(19) United States
(12) Patent Application Publication
(10) Pub. No.: US 2018/0033054 A1
(43) Pub. Date: Feb. 1, 2018

(54) CONTENT UNIT CREATION

(71) Applicant: Google Inc., Mountain View, CA (US)

(72) Inventors: Adam Champy, New York, NY (US); Roshan Khan, Seattle, WA (US); Vivek R. Rao, Redmond, WA (US)

(73) Assignee: Google Inc., Mountain View, CA (US)

(21) Appl. No.: 14/160,934

(22) Filed: Jan. 22, 2014

(51) Int. Cl. G06Q 30/02

(52) U.S. Cl. CPC G06Q 30/0273

(57) ABSTRACT

Methods, systems, and apparatus include computer programs encoded on a computer-readable storage medium, including a method for providing content. An example content presentation opportunity is identified as being associated with a reservation system. The content presentation opportunity is characterized, including creating a signature defined by signals. Creating the signature includes defining a value for each signature element, wherein an element corresponds to one or more of signals. The value for a respective element is based on a value for a respective signal as defined by the content presentation opportunity. At least a portion of the signature is provided for presentation to a user. The user is queried for an indication of a relative importance of signature elements. The signature is evaluated in context of an exchange system including creating a proposed campaign including selection criteria based on the signature and the received indication. Information related to the campaign is provided.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented. Some opportunities for presenting content can be similar to, or based on, other opportunities.

### SUMMARY

In general, one innovative aspect of the subject matter described in this specification can be implemented in methods that include a computer-implemented method for providing content. The method includes identifying an example of a content presentation opportunity from a publisher, the content presentation opportunity being characterized as being associated with a reservation system in which opportunities are booked in advance by an entity for presentation of their respective content. The method further includes characterizing, using one or more processors, the content presentation opportunity including creating a signature defined by a plurality of signals, wherein creating the signature includes defining a value for each element of the signature, wherein an element corresponds to one or more of the plurality of signals, and wherein the value for a respective element is based at least in part on a value for a respective signal as defined by the content presentation opportunity. The method further includes providing, for presentation to a user, at least a portion of the signature. The method further includes querying the user for an indication of a relative importance of elements included in the signature. The method further includes receiving the indication of the relative importance. The method further includes evaluating the signature in a context of an exchange system including creating a proposed campaign that includes selection criteria that are based at least in part on the signature and the received indication. The method further includes providing, for presentation to the user, information related to the proposed campaign.

These and other implementations can each optionally include one or more of the following features. The content presentation opportunity can be a prior direct purchase reservation from the publisher or a prior reservation associated with the user. The method can further include processing the signature including predicting a volume of traffic for the proposed campaign and a relative impact for inclusion of individual elements of the signature in the proposed campaign as selection criteria, and presenting at least a portion of the signature can further include providing relative impact information for one or more elements in the signature. The relative impact can be a relative cost for inclusion of the element in the proposed campaign. Querying the user for an indication of relative importance can include querying the user for an indication of which elements in the signature should be included in the proposed campaign, receiving the indication for which elements to include and creating the proposed campaign. Receiving the indication of relative importance can include receiving an indication of an element to exclude from the proposed campaign and excluding the element from the proposed campaign. The method can further include receiving an indication from the user to activate the proposed campaign, activating the proposed campaign including creating an actual campaign for inclusion in inventory of the exchange system, and reporting activity of the actual campaign over time to the user. The plurality of signals can include volume, cost and location signals, wherein the volume signal represents a number of presentation opportunities in the content presentation opportunity, the cost signal represents the cost for the presentation opportunities, and the location signal represents the location associated with the presentation opportunities. The plurality of signals can further include keywords or contextual information associated with the content presentation opportunity. The plurality of signals can further include one or more demographic signals. Providing information can include providing information for a buying opportunity in the exchange system that uses the proposed campaign. Providing information can include providing information for a new campaign for use in the exchange system that is similar to the content presentation opportunity of the reservation system. The new campaign can be based at least in part on the proposed campaign. The proposed campaign can include a monetization type selected from impression, interaction or conversion, and wherein the relative cost is based on predicted occurrences of monetization events after impressions of content from the proposed campaign.

In general, another innovative aspect of the subject matter described in this specification can be implemented in computer program products that include a computer program product tangibly embodied in a computer-readable storage device and comprising instructions. The instructions, when executed by one or more processors, cause the processor to: identify an example of a content presentation opportunity from a publisher, the content presentation opportunity being characterized as being associated with a reservation system in which opportunities are booked in advance by an entity for presentation of their respective content; characterize the content presentation opportunity including creating a signature defined by a plurality of signals, wherein creating the signature includes defining a value for each element of the signature, wherein an element corresponds to one or more of the plurality of signals, and wherein the value for a respective element is based at least in part on a value for a respective signal as defined by the content presentation opportunity; provide, for presentation to a user, at least a portion of the signature; query the user for an indication of a relative importance of elements included in the signature; receive the indication of the relative importance; evaluate the signature in a context of an exchange system including creating a proposed campaign that includes selection criteria that are based at least in part on the signature and the received indication; and provide, for presentation to the user, information related to the proposed campaign.

These and other implementations can each optionally include one or more of the following features. The content presentation opportunity can be a prior direct purchase reservation from the publisher or a prior reservation associated with the user. The computer plurality of signals can include volume, cost and location signals, wherein the volume signal represents a number of presentation opportunities in the content presentation opportunity, the cost signal represents the cost for the presentation opportunities, and the location signal represents the location associated with the presentation opportunities.

In general, another innovative aspect of the subject matter described in this specification can be implemented in systems, including a system comprising one or more processors and one or more memory elements including instructions. The instructions, when executed, cause the one or more processors to: identify an example of a content presentation opportunity from a publisher, the content presentation opportunity being characterized as being associated with a reservation system in which opportunities are booked in advance by an entity for presentation of their respective content; characterize the content presentation opportunity including creating a signature defined by a plurality of signals, wherein creating the signature includes defining a value for each element of the signature, wherein an element corresponds to one or more of the plurality of signals, and wherein the value for a respective element is based at least in part on a value for a respective signal as defined by the content presentation opportunity; provide, for presentation to a user, at least a portion of the signature; query the user for an indication of a relative importance of elements included in the signature; receive the indication of the relative importance; evaluate the signature in a context of an exchange system including creating a proposed campaign that includes selection criteria that are based at least in part on the signature and the received indication; and provide, for presentation to the user, information related to the proposed campaign.

These and other implementations can each optionally include one or more of the following features. The content presentation opportunity can be a prior direct purchase reservation from the publisher or a prior reservation associated with the user. The computer plurality of signals can include volume, cost and location signals, wherein the volume signal represents a number of presentation opportunities in the content presentation opportunity, the cost signal represents the cost for the presentation opportunities, and the location signal represents the location associated with the presentation opportunities.

Particular implementations may realize none, one or more of the following advantages. A campaign (e.g., an advertisement campaign) can be created automatically from a content presentation opportunity, and a user can indicate a relative importance of each element in the campaign before the campaign is activated.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A shows an example system for providing content.

FIG. 2B is a diagram of an example user interface showing proposed campaign information.

FIG. 3 is a flowchart of an example process for providing information for a campaign created from a content presentation opportunity.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, computer program products and mechanisms are described for creating a proposed campaign that includes selection criteria based at least in part on a signature of a content presentation opportunity. For example, the content presentation opportunity can be associated with a prior direct purchase reservation from a publisher or a prior reservation associated with a user. The selection criteria of the proposed campaign can include plural elements that are associated with a signature (e.g., volume, cost, location and other signals) associated with a prior reservation. Each element can be associated with a defined value for use in designating a relative importance of the elements. In some implementations, the user can view and/or modify information for the proposed campaign. The user can optionally indicate that the proposed campaign be activated, e.g., used to create an actual campaign in an exchange system. In some implementations, the systems and methods proposed can be used in other applications including those associated with the delivery of other content items, such as in a reservation based system.

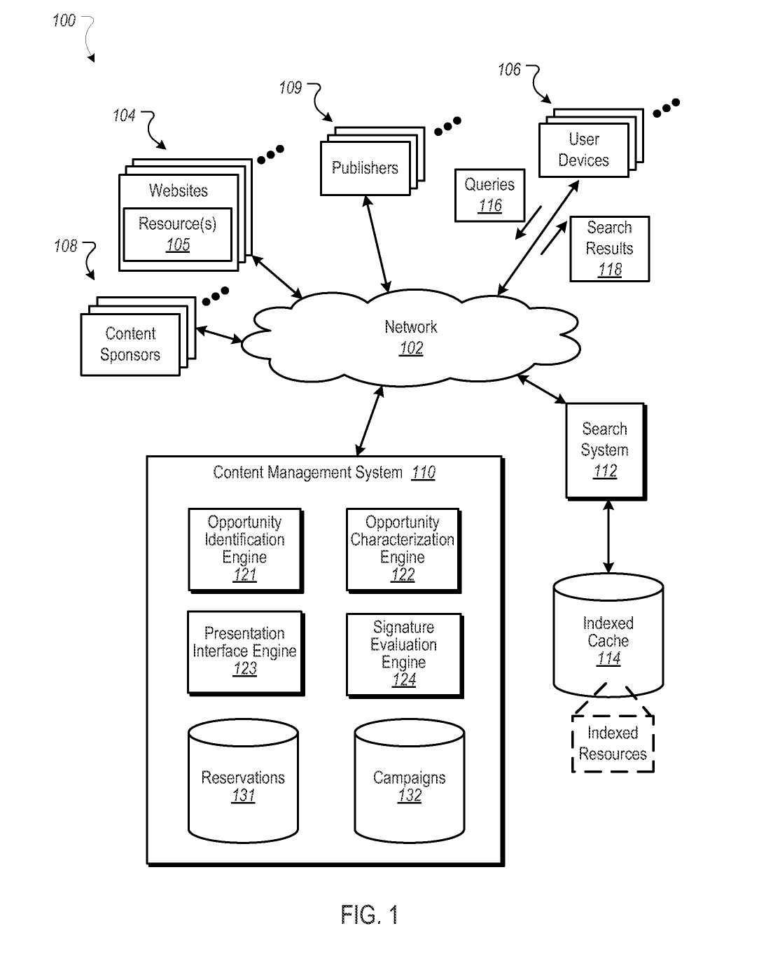

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices (e.g., access devices) 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. A data store of reservations 131, for example, can include prior direct purchase reservations provided by publishers and prior reservations associated with a specific entity. A data store of campaigns 132, for example, can include campaigns (e.g., advertisement campaigns) for providing content items (e.g., content items) using an exchange system (e.g., the content management system 110) and selected for presentation based on selection criteria.

The content management system 110 can include plural engines, some or all of which may be combined or separate, and may be co-located or distributed (e.g., connected over the network 102). An opportunity identification engine 121, for example, can identify an example of a content presentation opportunity from a publisher, such as one associated with a direct purchase reservation of the publisher or a prior reservation associated with an entity. An opportunity characterization engine 122, for example, can characterize the content presentation opportunity to create a signature defined by a plurality of signals. A presentation interface engine 123, for example, can provide at least a portion of the signature for presentation to an entity, query the entity for an indication of a relative importance of elements included in the signature, receive the indication, and provide information related to a proposed campaign that is created using the content presentation opportunity and the identified relative importance of elements. A signature evaluation engine 124, for example, can evaluate the signature in a context of an exchange system including creating a proposed campaign that includes selection criteria that are based, at least in part, on the signature and the received indication.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the Universal Resource Locator (URL) of the webpage. Search results pages can also include one or more slots in which other content items (e.g., advertisements) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

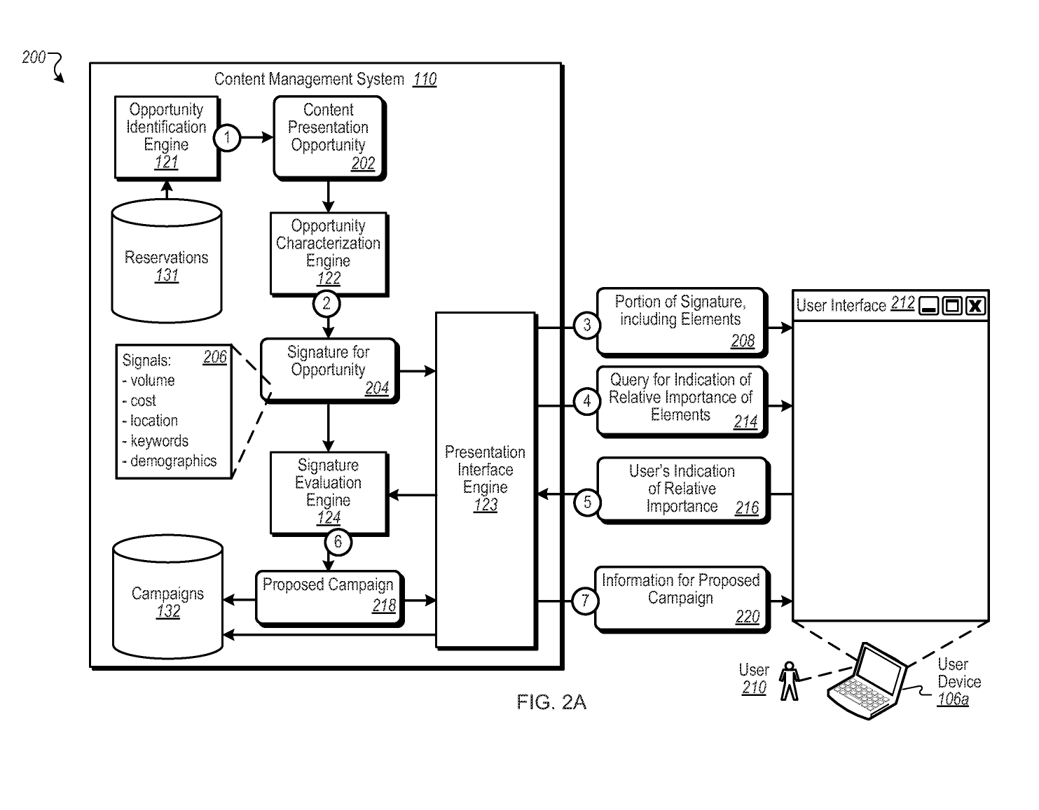

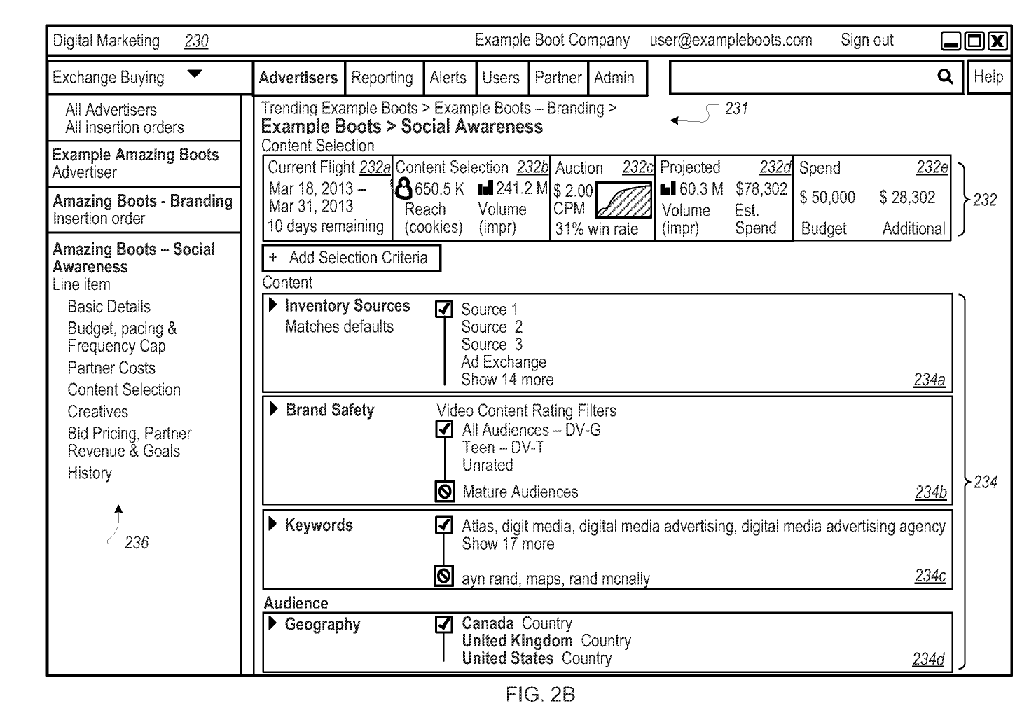

FIG. 2A shows an example system 200 for providing content. In some implementations, the system 200 can be used, e.g., to identify and characterize a content presentation opportunity 202 (e.g., a reservation 131) for presentation to a user 210 in a user interface 212. For example, presenting information associated with the content presentation opportunity 202 can include presenting specific elements in a signature associated with the content presentation opportunity 202. The user 210 can identify the relative importance of the elements, e.g., from which the content management system 110 can produce a proposed campaign. In some implementations, the user 210 can elect to activate the proposed campaign, and an actual campaign can be created for inclusion into an inventory of campaigns of the exchange system.

At stage 1, for example, the opportunity identification engine 121 can identify an example of a content presentation opportunity 202 from a publisher, such as a direct purchase reservation from the publisher 109 or a prior reservation associated with an entity. The content presentation opportunity can be characterized, for example, as being associated with a reservation system in which opportunities are booked in advance by an entity for presentation of their respective content. The identified content presentation opportunity 202 can be a specific one of the reservations 131, such as a reservation for content items (e.g., advertisements) associated with content sponsors 108. The content presentation opportunity 202, for example, can be a reservation placed in the past by an entity to provide a set number of impressions, and providing content at each presentation. The reservation, for example, can have an associated budget, designated number of impressions, time constraints, designated source(s) of inventory, designated audience, associated keywords, specified geography, and other characteristics.

At stage 2, for example, the opportunity characterization engine 122 can characterize the content presentation opportunity 202 to create a signature 204 defined by a plurality of signals. The signals, for example, can correspond to aspects of the reservation that identify how and when impressions of content are to be provided, as specified in the reservation. For example, the signals can include volume signals, cost signals, and/or location signals. Volume signals, for example, can represent a number of presentation opportunities in the content presentation opportunity. Cost signals, for example, can represent costs associated with the presentation opportunities. Location signals, for example, can represent the geographic locations (e.g., countries, regions or other locations) associated with the presentation opportunities. Other example types of signals include time (e.g., associated with the reservation), budget, size of the ad unit, site (if available), view ability rate (% seen), verification signals (e.g., indicating brand safety, such as not appearing on porn sites), interests (e.g., interest user list targeting or list membership), demographics (e.g., gross ratings points or panel-corrected demographics of the item) and reach (e.g., number of users viewing the content). In some implementations, reach information can be calculated using historical information, e.g., to create metrics such as gross ratings points that are derived from pure cookie reach and/or unique device reach. In some implementations, reach information can be used to predict a projected reach of a campaign, e.g., that has similar characteristics as the presentation opportunity 202.

To create the signature 204, for example, the opportunity characterization engine 122 can define a value for each element of the signature. Each element, for example, can correspond to one or more of the plurality of signals, and the value for a respective element can be based, at least in part, on a value for a respective signal as defined by the content presentation opportunity 202. In some implementations, the plurality of signals can further include keywords (including negative keywords) or contextual information associated with the content presentation opportunity. In some implementations, the signals can be associated with categories for the presentation opportunity, and the elements can correspond to specific instances of aspects in the signal with which values can be associated. For example, the content presentation opportunity 202 can be a reservation for reserving impressions of a boot advertisement. The signature 204 in this example can include signals related to the presentation of the impressions, including statistics associated with the reservation and the types of users who were presented with the associated content. For example, values for elements of the signature can include information for the volume and cost of impressions, content selection parameters (e.g., inventory sources, brand-related filters and keywords), and audience reach (e.g., demographics, interests, geography, and unique first party total audience reached).

At stage 3, for example, the presentation interface engine 123 can provide at least a portion 208 of the signature 204, e.g., for presentation to a user 210 on a user device 106a. For example, the presentation interface engine 123 can, when presenting the signature, use elements from some or all of the signals 206. In some implementations, information associated with the portion 208 can be presented in a user interface 212 which can display, to the user 210, elements from the signals 206 that are included in the portion 208. In some implementations, the user interface 212 can be similar to a user interface 230 described in detail with respect to FIG. 2B.

At stage 4, for example, the presentation interface engine 123 can query (214) the user 210 for an indication of a relative importance of elements included in the signature. For example, based on receipt of the query 214, the user interface 212 can include messages, controls and/or other components that allow the user 210 to select, rank and/or score elements based on their importance, e.g., in a campaign that can be created from the elements. The user 210 can indicate, using the controls, that elements in the signature related to potential audience reach, for example, are more important than, for example, a specific volume.

At stage 5, for example, the presentation interface engine 123 can receive the indication 216 of the relative importance of elements included in the signature. For example, the user's indication can include a list of the elements that the user identified as important. In some implementations scores and/or rankings can be included with the list. The received indication 216 can also identify, for example, the elements of the content presentation opportunity 202 that the user 210 indicates are not important.

At stage 6, for example, the signature evaluation engine 124 can evaluate the signature 204 in a context of an exchange system, including creating a proposed campaign 218 that includes selection criteria that are based, at least in part, on the signature 204 and the received indication 216. For example, the signature evaluation engine 124 can base the created proposed campaign 218 on the signature 204. The signature evaluation engine 124 can adjust the proposed campaign 218 using user 210 inputs specified in the user interface 212 that indicate the relative importance of the elements.

At stage 7, for example, the presentation interface engine 123 can provide, for presentation to the user, information 220 related to the proposed campaign 218. For example, the provided information can be displayed in the user interface 212 and can include elements identified by the user 210 as being important. In some implementations, the information 220 related to the proposed campaign 218 can be presented in the user interface 230 described with reference to FIG. 2B.

In some implementations, the user 210 can elect to activate the proposed campaign 218. For example, the presentation interface engine 123 can receive an indication from the user 210 to activate the proposed campaign 218. Based on this input, for example, the content management system 110 can activate the proposed campaign 218, including creating an actual campaign for inclusion in an inventory of the exchange system, e.g., the campaigns 132. In some implementations, the content management system 110 can report, to the user 210, activity associated with the actual campaign that occurs over time.

FIG. 2B is a diagram of an example user interface 230 showing proposed campaign information. For example, the campaign information can include or represent a synthetic line item that is based on elements from the signature 204 of the identified content presentation opportunity 202. The information can be used by the user 210, for example, to identify content selection parameters in a campaign for presentation of content items (e.g., advertisements). In some implementations, the campaign can be identified by a header 231.

In some implementations, the user interface 230 includes elements 232, e.g., that provide information associated with the signals 206 related to at least volume and cost. For example, current flight information 232a can include information associated with the identified content presentation opportunity 202. The information can include, for example, a timeframe associated with the associated reservation.

Current volume information 232b, for example, can identify a current reach and a current volume associated with the reservation. The current reach, for example, can identify a number of users who have generated cookies, e.g., by interacting with the associated content item. The current volume, for example, can identify an actual number of users to which impressions of the content have been provided.

Auction information 232c, for example, can identify up-to-date auction information associated with the identified content presentation opportunity 202. For example, the auction information 232c can include an estimated cost per one thousand impressions, a graph indicating, and a bid win rate percentage. Other information can be provided.

Projected volume information 232d, for example, can identify a proposed volume and an estimated spend associated with the campaign. The proposed volume, for example, can identify a proposed number of impressions. The estimated spend, for example, can identify a total monetary amount that is estimated to be spent during the proposed campaign. In some implementations, other projected values can be used, e.g., an estimated reach associated with the exchange/auction format, calculations or estimated gross rating points, target rating points, and/or other calculated or projected values associated with reach and/or demographics.

Projected cost information 232e, for example, can identify current and projected amounts spent. For example, the projected cost information 232e can include a budget amount and an additional amount. A sum of the two amounts, for example, can equal the estimated spend amount included in the projected volume information 232d.

In some implementations, the user interface 230 includes content selection elements 234. For example, the selection elements 234 can identify one or more sources used in the identified content presentation opportunity 202 and that can also be used in the proposed campaign. For example, the user 210 can be presented with content selection signals 234 that are identified from the content presentation opportunity 202, and the user can select the specific elements to use in the campaign.

Inventory sources 234a, for example, can identify content sources. The sources can include, for example, various sources of content, advertisement exchanges, and/or other sources.

Verification elements 234b (e.g., brand safety) can indicate specific audiences, sites, or groups of sites on which content items are appearing, or should not appear.

Keyword elements 234c, for example, can identify specific lists of keywords. In some implementations, lists of negative keywords can also be used.

Location elements 234d (e.g., geography-based) can identify one or more countries. For example, individual countries can be designated (e.g., checked or unchecked) to permit (or prevent) the presentation of the campaign in those countries.

Controls 236, for example, can be used to select or to identify the relative importance of elements from the content presentation opportunity 202 that are used in the proposed campaign 218. For example, the user may specify that inventory sources 234a and keyword elements 234c are of greater importance, and that location elements 234d are of a lesser importance. In some implementations, the user can assign scores, rankings or weights to different elements in order to indicate their relative importance.

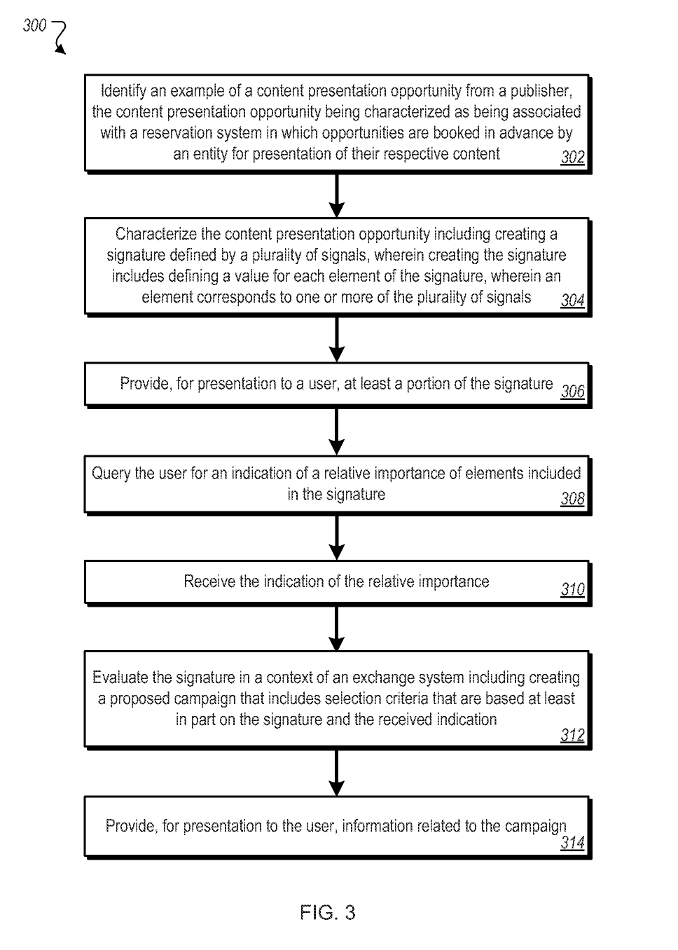

FIG. 3 is a flowchart of an example process 300 for providing information for a campaign created from a content presentation opportunity. In some implementations, the content management system 110 can perform stages of the process 300 using instructions that are executed by one or more processors. FIGS. 1-2B are used to provide example structures for performing the steps of the process 300.

An example of a content presentation opportunity from a publisher is identified (302). In some implementations, the content presentation opportunity is characterized as being associated with a reservation system in which opportunities are booked in advance by an entity for presentation of their respective content. For example the opportunity identification engine 121 can identify a particular one of the reservations 131 for presentation to the user 210, e.g., for developing a proposed campaign (e.g., an advertisement campaign).

In some implementations, the content presentation opportunity can be a prior direct purchase reservation from the publisher or a prior reservation associated with the user. For example, the content presentation opportunity 202 can be a reservation related to the Example Boots Company for which the elements associated with signals 206 of the signature 204 can be presented in the user interface 230.

The content presentation opportunity is characterized, including creating a signature defined by a plurality of signals (304). Creating the signature includes defining a value for each element of the signature, wherein an element corresponds to one or more of the plurality of signals, and wherein the value for a respective element is based at least in part on a value for a respective signal as defined by the content presentation opportunity. As an example, the opportunity characterization engine 122 can characterize the content presentation opportunity 202 to create a signature 204 defined by a plurality of signals 206. The signals, for example, can include volume signal, cost signal, location signals, and/or other signals as described above. In some implementations, to create the signature 204, the opportunity characterization engine 122 can, for example, analyze parameters in the content presentation opportunity 202, such as parameters defined for a reservation. In some implementations, the opportunity characterization engine 122 can also analyze results associated with the content presentation opportunity 202, such as information about user interaction, budget spent or other information. The content presentation opportunity 202 can be characterized based on the analysis. The analysis, for example, can include determining certain values for elements in the signals 206 associated with the content presentation opportunity 202. For example, for a reservation, the values can quantify and qualify volume (e.g., impressions), costs (e.g., spend, budget), and audience reach (e.g., including location). The purpose of this information is to allow the user 210 to evaluate aspects of the reservation for potential use in creating a new campaign. For example, the information can be used to create and present information for a potential new campaign in the user interface 230, described with respect to FIG. 2B.

In some implementations, the plurality of signals can include volume, cost and/or location signals, wherein the volume signals represent a number of presentation opportunities in the content presentation opportunity, the cost signals represent the cost for the presentation opportunities, and the location signals represent locations associated with the presentation opportunities. For example, volume-related signals 206 can be associated with current volume information 232b and projected volume information 232d presented as elements in the user interface 230. As another example, cost-related signals 206 can be associated with auction information 232c and projected cost information 232e. Location-related signals 206, for example, can be associated with location elements 234d. Other types of signals are possible, including, keywords or contextual information signals associated with the content presentation opportunity 202, e.g., presented as keyword elements 234c. In some implementations, the plurality of signals can further include one or more demographic signals, e.g., age, gender or other demographic parameters.

At least a portion of the signature is provided for presentation to a user (306). For example, the presentation interface engine 123 can provide the portion 208 of the signature 204 for presentation to the user 210 on the user device 106a. In this example, the portion 208 can include some or all of the signals 206. In some implementations, elements from the signals can be presented in the user interface 230 described in detail with respect to FIG. 2B.

The user is queried for an indication of a relative importance of elements included in the signature (308). For example, the presentation interface engine 123 can provide the query 214 to the user device 106a requesting that the user 210 is to provide an indication of the relative importance of elements included in the signature. In some implementations, the user 210 can respond to the query using controls on the user interface 230.

In some implementations, querying the user for an indication of relative importance can include querying the user for an indication of which elements in the signature should be included in the proposed campaign, receiving the indication for which elements to include and creating the proposed campaign. For example, using the user interface 230, the user 210 can identify which elements (e.g., from among elements 232 and 234) are important, including an indication of each of the elements' relative importance.

The indication of the relative importance is received (310). As an example, the presentation interface engine 123 can receive the indication 216 from the user device 106a. In some implementations, the indication 216 can be received as a result of user 210 input on the user interface 230. The received indication 216 can identify the elements of the content presentation opportunity 202 that the user 210 indicates are important, e.g., and should be used in creating a proposed campaign.

In some implementations, receiving the indication of relative importance can include receiving an indication of an element to exclude from the proposed campaign and excluding the element from the proposed campaign. For example, the indication 216 can also identify the elements of the content presentation opportunity 202 that the user 210 indicates are not important, e.g., should not be used in creating a proposed campaign.

The signature is evaluated in a context of an exchange system, including creating a proposed campaign that includes selection criteria that are based, at least in part, on the signature and the received indication (312).

In some implementations, the process 300 can further include processing the signature, including predicting a volume of traffic for the proposed campaign and a relative impact for inclusion of individual elements of the signature in the proposed campaign as selection criteria, wherein presenting at least a portion of the signature further includes providing relative impact information for one or more elements in the signature. For example, the signature evaluation engine 124 can predict volume-related information, such as information associated with projected volume information 232d included in the user interface 230. In some implementations, the signature evaluation engine 124 can generate detailed information, for example, that identifies each element's relative contribution (e.g., an estimated absolute or percentage contribution) associated with each of the elements as they pertain to the projected volume.

In some implementations, the relative impact can be a relative cost for inclusion of the element in the proposed campaign. For example, the signature evaluation engine 124 can generate detailed information that identifies costs associated with each of the elements as they pertain to the projected volume, e.g., assuming that the elements are included in the proposed campaign.

Information related to the proposed campaign is provided for presentation to the user (314). As an example, the presentation interface engine 123 can provide information 220 associated with the proposed campaign 218 to the user device 106a, e.g., for presentation in the user interface 230.

In some implementations, providing information related to the proposed campaign can include providing information for a buying opportunity in the exchange system that uses the proposed campaign. For example, the information 220 provided by the presentation interface engine 123 can include information presentable to the user for offering and accepting a buy opportunity, e.g., in the form of the proposed campaign 218. In some implementations, the information provided can include information for a new campaign for use in the exchange system that is similar to the content presentation opportunity of the reservation system. For example, the new campaign can be based, at least in part, on the proposed campaign. In some implementations, the user can make changes to elements associated with the proposed campaign 218, e.g., iteratively and including re-calculated buying opportunities.

In some implementations, the process 300 can further include a mechanism for activating the proposed campaign. For example, after the user 210 is prompted with an option for activation (e.g., in the user interface 230), the presentation interface engine 123 can receive an indication from the user to activate the proposed campaign. In this example, the content management system 110 can activate the proposed campaign 218, including creating an actual campaign for inclusion in inventory of the exchange system. In some implementations, subsequent to activation of the campaign, results of the campaign can be provided for presentation to the user, e.g., by reporting activity of the actual campaign over time to the user.

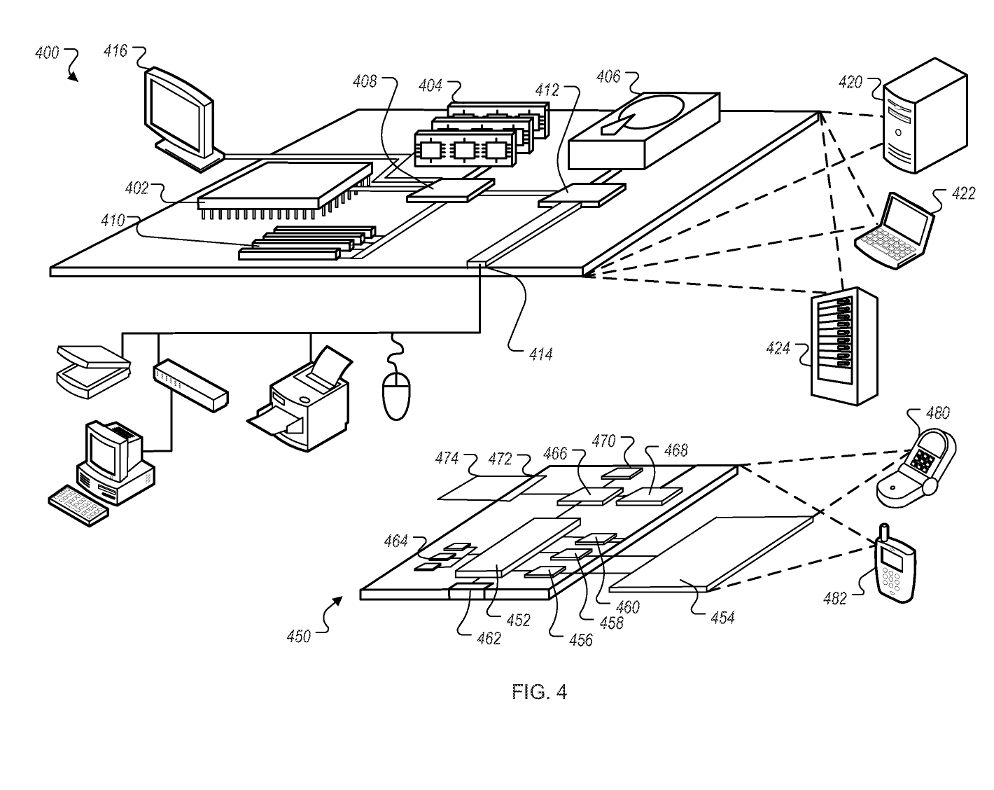

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more computing devices, a content presentation reservation that is booked in advance of a time at which a particular portion of content is presented with a particular web property provided by a publisher, the content presentation reservation being booked by an entity that provides the particular portion of content and specifying a number of presentations of the particular portion of content are to occur on the particular web property over a given amount of time;
identifying, by the one or more computing devices, signals that characterize aspects of the content presentation reservation, including identifying a number of presentations reserved and one or more attributes of users that visit the particular web property provided by the publisher;
creating, by the one or more computing devices, a signature defined by the signals that characterize the content presentation reservation;
providing, to the entity that provides the particular portion of content, a user interface that visually presents the signals that characterize the content presentation reservation along with controls that enable the entity to input a level of importance for each of at least some of the signals;
querying, through the user interface, a user for an indication of a relative importance of each of the at least some of the signals relative to others of the signals included in the signature;
receiving, from the user and through the user interface in response to the querying, input specifying the relative importance of each of the at least some of the signals;
automatically creating a proposed campaign using the signals from the signature and the relative importance of each of the at least some of the signals;
predicting a volume of traffic for the proposed campaign when used to distribute content with different web properties using the proposed campaign rather than the content presentation reservation;
receiving, from the entity, activation of the proposed campaign; and
at a time that is subsequent to a time when the campaign is activated and in response to one or more received requests for content, distributing data that incorporates content into various electronic resources according to the campaign rather than the content presentation reservation.

2. The method of claim 1 wherein the content presentation reservation is a prior direct purchase reservation from the publisher or a prior reservation associated with the user.

3. The computer-implemented method of claim 1 further comprising processing the signature including predicting a relative impact for inclusion of individual elements of the signature in the proposed campaign as selection criteria, and providing relative impact information for one or more elements in the signature.

4. The computer-implemented method of claim 3 wherein the relative impact is a relative cost for inclusion of an element in the proposed campaign.

5. The computer-implemented method of claim 1 wherein querying the user for an indication of relative importance includes querying the user for an indication of which elements in the signature should be included in the proposed campaign, receiving the indication for which elements to include and creating the proposed campaign.

6. The computer-implemented method of claim 1 wherein receiving the input specifying the relative importance includes receiving an indication of an element to exclude from the proposed campaign and excluding the element from the proposed campaign.

7. The computer-implemented method of claim 1 further comprising:
reporting activity of the activated proposed campaign over time to the user.

8. (canceled)

9. The computer-implemented method of claim 1 wherein the signals include keywords or contextual information associated with the content presentation reservation.

10. The computer-implemented method of claim 9 wherein the signals further include one or more demographic signals.

11. The computer-implemented method of claim 1, further comprising providing information for a buying opportunity in an exchange system that uses the proposed campaign.

12. The computer-implemented method of claim 1, further comprising providing information for a new campaign for use in an exchange system that is similar to the content presentation reservation.

13. (canceled)

14. The computer-implemented method of claim 4 wherein the proposed campaign includes a monetization type selected from impression, interaction or conversion, and wherein a relative cost is based on predicted occurrences of monetization events after impressions of content from the proposed campaign.

15. A computer program product embodied in a non-transitive computer-readable medium including instructions, that when executed, cause one or more processors to perform operations comprising:
identifying a content presentation reservation that is booked in advance of a time at which a particular portion of content is presented with a particular web property provided by a publisher, the content presentation reservation being booked by an entity that provides the particular portion of content and specifying a number of presentations of the particular portion of content are to occur on the particular web property over a given amount of time;
identifying signals that characterize aspects of the content presentation reservation, including identifying a number of presentations reserved and one or more attributes of users that visit the particular web property provided by the publisher;
creating a signature defined by the signals that characterize the content presentation reservation;
providing, to the entity that provides the particular portion of content, a user interface that visually presents the signals that characterize the content presentation reservation along with controls that enable the entity to input a level of importance for each of at least some of the signals;
querying, through the user interface, a user for an indication of a relative importance of each of the at least some of the signals relative to others of the signals included in the signature;
receiving, from the user and through the user interface in response to the querying, input specifying the relative importance of each of the at least some of the signals;
automatically creating a proposed campaign using the signals from the signature and the relative importance of each of the at least some of the signals;
predicting a volume of traffic for the proposed campaign when used to distribute content with different web properties using the proposed campaign rather than the content presentation reservation;
receiving, from the entity, activation of the proposed campaign; and
at a time that is subsequent to a time when the campaign is activated and in response to one or more received requests for content, distributing data that incorporates content into various electronic resources according to the campaign rather than the content presentation reservation.

16. The computer program product of claim 15 wherein the content presentation reservation is a prior direct purchase reservation from the publisher or a prior reservation associated with the user.

17. (canceled)

18. A system comprising:
an opportunity identification engine for identifying a content presentation reservation that is booked in advance of a time at which a particular portion of content is presented with a particular web property provided by a publisher, the content presentation reservation being booked by an entity that provides the particular portion of content and specifying a number of presentations of the particular portion of content are to occur on the particular web property over a given amount of time;
an opportunity characterization engine for identifying signals that characterize aspects of the content presentation reservation, including identifying a number of presentations reserved and one or more attributes of users that visit the particular web property provided by the publisher and creating a signature defined by the signals that characterize the content presentation reservation;
a presentation interface engine for:
providing, to the entity that provides the particular portion of content, a user interface that visually presents the signals that characterize the content presentation reservation along with controls that enable the entity to input a level of importance for each of at least some of the signals;
querying, through the user interface, a user for an indication of a relative importance of each of the at least some of the signals relative to others of the signals included in the signature; and
receiving, from the user and through the user interface in response to the querying, input specifying the relative importance of each of the at least some of the signals; and
a signature evaluation engine for:
automatically creating a proposed campaign using the signals from the signature and the received indication of the relative importance of each of the at least some of the signals;
predicting a volume of traffic for the proposed campaign when used to distribute content with different web properties using the proposed campaign rather than the content presentation reservation;
receiving, from the entity, activation of the proposed campaign; and
at a time that is subsequent to a time when the proposed campaign is activated and in response to one or more received requests for content, distributing data that incorporates content into various electronic resources according to the campaign rather than the content presentation reservation.

19. The system of claim 18 wherein the content presentation reservation is a prior direct purchase reservation from the publisher or a prior reservation associated with the user.

20. (canceled)

21. The method of claim 1 further comprising identifying, for the content presentation reservation, a timeframe, a reach metric indicating a number of users to whom impressions of the content have reached, an auction win rate, an impression volume, an estimated spend amount, and a budget.

22. The computer program product of claim 15 further comprising identifying, for the content presentation reservation, a timeframe, a reach metric indicating a number of users to whom impressions of the content have reached, an auction win rate, an impression volume, an estimated spend amount, and a budget.

23. The system of claim 18, the presentation interface engine further identifying, for the content presentation reservation, a timeframe, a reach metric indicating a number of users to whom impressions of the content have reached, an auction win rate, an impression volume, an estimated spend amount, and a budget.

24. The computer-implemented method of claim 1 further comprising:
detecting, over one or more networks, cookies generated from one or more client device interactions with impressions of digital content items; and
indexing, in a data repository, data representing the detected cookies; and
wherein identifying the signals that characterize aspects of the content presentation reservation further includes:
searching the data repository for indexed data representing one or more cookies associated with one or more impressions of one or more particular digital content items for a content presentation reservation; and
at least partly based on cookies identified from the indexed data, automatically analyzing, using the one or more computing devices, the content presentation reservation, including analyzing results of impressions that have been provided for the content presentation reservation.

25. The computer program product of claim 15, the operations further comprising:
detecting, over one or more networks, cookies generated from one or more client device interactions with impressions of digital content items; and
indexing, in a data repository, data representing the detected cookies; and
wherein identifying the signals that characterize aspects of the content presentation reservation further includes:
searching the data repository for indexed data representing one or more cookies associated with one or more impressions of one or more particular digital content items for a content presentation reservation; and
at least partly based on cookies identified from the indexed data, automatically analyzing the content presentation reservation, including analyzing results of impressions that have been provided for the content presentation reservation.

26. The system of claim 18, the opportunity characterization engine further:
detecting, over one or more networks, cookies generated from one or more client device interactions with impressions of digital content items; and
indexing, in a data repository, data representing the detected cookies; and
wherein identifying the signals that characterize aspects of the content presentation reservation further includes:
searching the data repository for indexed data representing one or more cookies associated with one or more impressions of one or more particular digital content items for a content presentation reservation; and
at least partly based on cookies identified from the indexed data, automatically analyzing, using one or more processors, the content presentation reservation, including analyzing results of impressions that have been provided for the content presentation reservation.
